(19) United States
(12) Patent Application Publication
(10) Pub. No.: US 2025/0131605 A1
(43) Pub. Date: Apr. 24, 2025

(54) OPTIMIZING PROMPTS FOR ARTIFICIAL INTELLIGENCE (AI) IMAGE GENERATION FOR IMAGE-BASED INTERNET SEARCHING

(71) Applicant: eBay Inc., San Jose, CA (US)

(72) Inventor: Nitzan MEKEL, Purchase, NY (US)

(21) Appl. No.: 18/491,509

(22) Filed: Oct. 20, 2023

(51) Int. Cl. G06T 11/00; G06F 16/432; G06T 7/10

(52) U.S. Cl. CPC G06T 11/00; G06F 16/434; G06T 7/10

(57) ABSTRACT

Image-based searching can provide enhanced search results compared to text-based searches. Techniques for generating images that can be used by search engines include generating an optimized image-model prompt using a language model from a text-based input. The optimized image-model prompt includes a more literal description of an item described by the text-based input. The optimized image-model prompt is provided to a language model that generates a photo-realistic image of the item. A search engine uses the photo-realistic image to identify and return search results.

### BACKGROUND

Image-based internet searching allows users to search for information using images instead of text keywords. By uploading or linking to an image, search engines analyze the visual content and provide relevant results, such as similar images, product details, or information about the objects and scenes depicted.

Generative AI (artificial intelligence) is a category of machine learning models that are capable of creating new data samples that are similar to a given set of training data. This may include tasks such as generating text, images, or music, and is often associated with various deep learning techniques.

### SUMMARY

At a high level, the technology may relate to AI techniques for optimizing prompts used to generate images for image-based searches. The technology may allow a user to enter a text-based input that is expanded by a language model to generate an optimized image-model prompt suitable for rending an image by an image model. The image may be used by search engines to identify search results that are more relevant to the initial text-based input than many traditional text-based searching methods afford.

To do so, a text-based input may be received at a search engine. The text-based input is provided to a language model, such as a text-based generative AI model. The language model may expand the text-based input to generate an optimized image-model prompt. The optimized image-model prompt may include additional text that is a more literal textual description of the object described by the text-based input.

The optimized image-model prompt may be provided to an image model. The image model may generate a photo-realistic image from text within the optimized image-model prompt. The photo-realistic image is provided to a search engine that outputs search results for the image. The search results may be provided to the user computing device.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 illustrates an example optimized image-model prompt as generated by a language model, in accordance with an aspect described herein;

FIG. 3 illustrates an example photo-realistic image as generated by an image model using the optimized image-model prompt, in accordance with an aspect described herein;

FIG. 4 illustrates an example modified optimized image-model prompt as modified by the language model, in accordance with an aspect described herein;

FIG. 5 illustrates an example segmented image generated using a segmentation engine, in accordance with an aspect described herein;

FIG. 6 illustrates an example modified image, as modified by the image model of using the modified optimized image-model prompt, in accordance with an aspect described herein;

FIG. 7 illustrates an example search using the photo-realistic image, in accordance with an aspect described herein;

FIG. 8 illustrates example search results using a text-based search, in accordance with an aspect described herein;

FIG. 9 illustrates example search results using an image-based search, in accordance with an aspect described herein;

FIGS. 10-12 illustrate block diagrams having various example methods for identifying an item as a search result, in accordance with aspects described herein;

FIG. 13 illustrates a block diagram having an example method for generating a segmented image for providing to an image model for modifying an initial photo-realistic image, in accordance with an aspect described herein;

FIG. 14 illustrates a block diagram having an example method for performing an updated image-based search using a modified image, in accordance with an aspect described herein; and

FIG. 15 illustrates an example computing device suitable for implementing aspects of the described technology, in accordance with an aspect described herein.

### DETAILED DESCRIPTION

Text-based internet searching may refer to the process of using a search engine to find information over a network, such as the Internet, by entering text queries. In this method, users input a series of words or phrases into a search system, and the search engine returns a list of items, including web pages, documents, images, or other types of files that are considered relevant to the query.

Conventionally, the search engine processes the text-based query to understand its intent. This may involve parsing the query, correcting misspellings, and sometimes expanding the query using synonyms or related terms, a process known as query expansion. Search engines maintain an extensive index of web pages and other online content. The processed query is used to search this index for matching results.

The search engine may use a ranking algorithm to sort the results based on various factors such as relevance, page quality, and the number of inbound links, among others. The sorted list of results is displayed to the user, usually with a title, a brief snippet of content, and the URL (uniform resource locator) of the page. The user can then click on these links to visit the web pages and access the information they were searching for.

Text-based internet searching has evolved significantly since its inception. Early search engines primarily used keyword matching and were not very sophisticated in understanding the context or semantics of a query. Modern search engines use complex algorithms that incorporate machine learning, natural language processing, and other advanced techniques to provide more accurate and contextually relevant results.

Despite its utility, text-based internet searching has limitations. One common issue is the “vocabulary mismatch,” where the terms used in the search query may not match the terms used in relevant documents. This can result in incomplete or less relevant search results. Various techniques like query expansion have been developed to mitigate this issue, but they come with their own set of challenges, such as the inclusion of irrelevant results.

Image-based searching, sometimes referred to as “reverse image searching,” is a type of search where an image is used as the query. In this method, users upload an image to a search engine, which then analyzes the image and returns a list of items that may include similar images or related information. The search engine may use various techniques like feature extraction, color histograms, and machine learning algorithms to identify patterns, shapes, and other characteristics within the image.

Conventionally, the search engine processes the image to extract key features such as color distribution, texture, and shapes. The extracted features are used to search a database of indexed images for matches. Similar to text-based searches, the search engine ranks the results based on similarity metrics, and the ranked results are provided back to a user computing device.

Image-based searching is particularly useful when the user cannot adequately describe what they are looking for in text. For example, identifying a landmark or a piece of art is often easier with an image than with a textual description. Image-based searching can be beneficial for users who are looking for products but do not know the exact name or brand. They can simply upload a picture of the item to find similar products.

Further, image-based searching provides a richer contextual framework for queries compared to text-based searching. A single image can encapsulate a multitude of elements—such as furniture, colors, textures, lighting, and more—that would otherwise require extensive textual description. This visual complexity allows for more precise and nuanced search results.

Additionally, images can resolve the ambiguity often present in text queries; for example, an image of an apple instantly clarifies whether the user is referring to the fruit or the tech company. The multifaceted information contained in an image, which can include multiple objects or concepts related in a specific way, offers a more comprehensive understanding of the user's intent. Moreover, images capture non-verbal elements like emotion, style, and atmosphere that are difficult to convey through text, or would at the least require extensive and verbose textual queries to try to capture such elements. Lastly, the universal nature of images transcends language barriers, making them particularly useful in a global context where text-based keywords might not translate effectively.

One significant limitation of image-based searching is the necessity to have access to a relevant image for the query. This becomes problematic in various scenarios, such as when you encounter a product you like in a physical store but cannot take a picture for an online search. Similarly, if you remember an image or scene but do not have a copy, text-based searches become your only option. Furthermore, technical constraints can hinder the utility of image-based searches; for instance, limited device capabilities or poor internet connectivity may prevent users from uploading images, thereby restricting them to text-based queries.

Search techniques, including image-based searching, are integral to the technical function of the Internet primarily because of the sheer volume and the diversity of content available online. The Internet hosts billions of web pages, images, videos, and other forms of data. Without sophisticated search and ranking algorithms, it would be virtually impossible for users to find relevant information in this vast sea of content. As an example, around the time of filing this application, a search query for “Kansas City Current” returned more than 1.17 billion results. This evidences how critical search and ranking techniques are to Internet functioning, as it would not be possible for a user to sift through each of these results, necessarily relying on the search engine instead.

As the Internet continues to grow, the complexity and variety of queries also increase. Text-based searches may not suffice for all types of queries, especially those that are visual or contextually complex. This is where specialized search techniques like image-based searching come into play, offering alternative ways to navigate the digital landscape and allowing search engines to provide the user with useful results among the trillions of possibilities.

In essence, search techniques are not just a useful feature, but instead, are a necessity for the Internet to function as a useful resource. They act as the organizing principle that makes the Internet accessible and navigable, turning an overwhelming amount of data into a structured and user-accessible environment.

Techniques provided by the technology disclosed herein improve image-based searching. The technology also offers mechanisms that allow users to take advantage of the ease of text-based inputs, while at the same time, further provide the benefits of image-based searching.

One example method that can capture some of the benefits of both text-based and image-based searching optimizes a textual input to generate an image suitable for performing an image search. For example, a user can enter a text-based input at a computing device, such as a desktop, phone, or even a smartwatch. The text-based input is provided to a language model, such as a text-based generative AI model.

In turn, the language model outputs an optimized image-model prompt. The optimized image-model prompt is an expanding prompt that is optimized to provide additional literal description of the text-based input. For example, if the user inputs a text-based input to search for a “black dress,” the language model may output an optimized image-model prompt that includes a literal description of a black dress, such as a description including the location and a description of attributes of the dress, including attributes that are not listed in the text-based input. Moreover, using many language models, a user can go back and forth during a dialogue, interacting with the language model until the language model provides an optimized image-model prompt that describes an image near to the user's intent.

In this way, the language model is optimizing the text-based input for use by an image model that will generate an image, such as that of the black dress. For example, diffusion models may be used to generate images responsive to textual descriptions. In this case, the image model is generating an image based on the literal description of the optimized image-model prompt. The optimized image-model prompt helps constrain the image model in a way that the image model is more likely to produce a relevant image from the query. For instance, a detailed description of a dress that includes the location and description of its various attributes will constrain the image model more than the initial text-based input of just a “black dress,” ultimately resulting in an image more likely to return useful search results.

Once the image has been generated by the image model from the optimized image-model prompt, the image can be provided to a search engine for an image-based search. The search engine uses the image to identify and return search results.

Advantageously, this technique, and others that will be further described, helps solve many problems inherent in conventional text- and image-based search methods, while still capturing some of the benefits of these methods, e.g., the ease of text-based inputs and the robust search capabilities afforded by image-based search techniques.

For example, this method allows computing devices without a camera to have the benefits of an image-based search. Smaller devices like smartwatches are generally better suited for textual inputs over image inputs due to several constraints. The limited screen size makes viewing and selecting images challenging, while the device's reduced processing power and battery life make text-based searches more efficient. Additionally, the user interface on such devices is optimized for quick, simple interactions, making textual inputs more practical. Moreover, not all smartwatches and smaller computing devices have cameras, and even those that do may offer lower resolutions that limit the effectiveness of image-based searches. However, the method described herein allows users to use such devices, yet still capture the benefits of image-based searching, since text-based inputs can be provided to these smaller devices, and the text-based inputs can be converted to an image for image-based searching.

As noted, in some cases, network availability may be limited. In such cases, devices may not have the connection speed or bandwidth to upload an image for an image-based search. Techniques provided by the disclosed technology allow users to enter text, including relatively minor amounts of text, since the language model optimizes the text for image generation. To upload text requires far less data transfer relative to images. This allows for devices running on lower connectivity to effectively use and receive the benefits of an image-based search.

Further, techniques provided herein can help improve some aspects of the computing device itself. For instance, conventional methods, such as strict text-based searching, may require users to sift through multiple pages of results and perhaps even click through to multiple websites to find the information they need. This can consume more bandwidth compared to the disclosed techniques that further optimize and enhance the search results provided to users, which may quickly yield the desired result, thus saving data transfer. Moreover, since the methods provided herein may provide more targeted search results compared to conventional methods, this may result in a device's cache storing fewer irrelevant pages, thus leading to more efficient use of the device's memory resources.

Many of the techniques that are described are not well-understood, routine, or conventional in the relevant technological fields. For instance, it is believed that query expansion techniques for optimizing text-based input to generate prompts that are usable to generate images is not a conventional practice. It is also believed that the combination of expanding a text-based input to a literal description of an image of an item, which is used to generate an image and perform an image-based search, is not a conventional process, nor is it routinely performed in relevant technological fields.

It will be realized that the method previously described is only an example that can be practiced from the description that follows, and it is provided to more easily understand the technology and recognize its benefits. Additional examples are now described with reference to the figures.

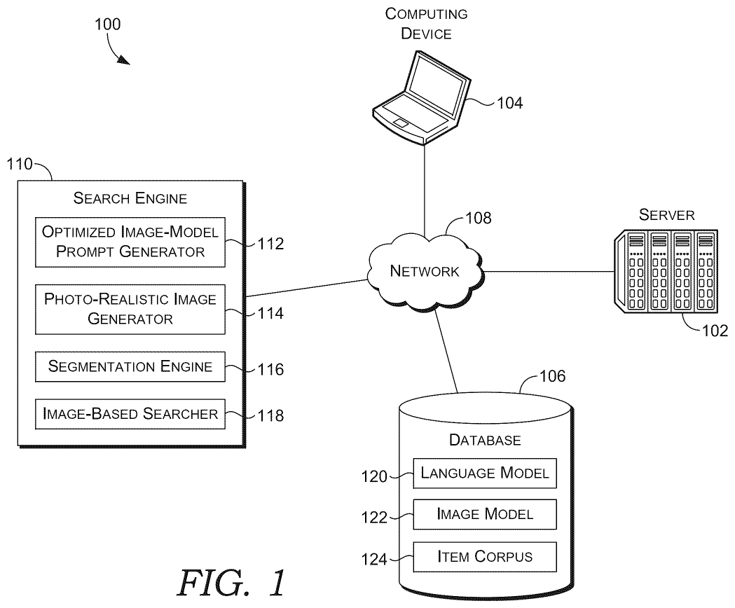

With reference now to FIG. 1, an example operating environment 100 in which aspects of the technology may be employed is provided. Among other components or engines not shown, operating environment 100 comprises server 102, computing device 104, and database 106, which are communicating via network 108 to search engine 110.

Database 106 generally stores information, including data, computer instructions (e.g., software program instructions, routines, or services), or models used in embodiments of the described technologies. For instance, database 106 may store computer instructions for implementing functional aspects of search engine 110. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

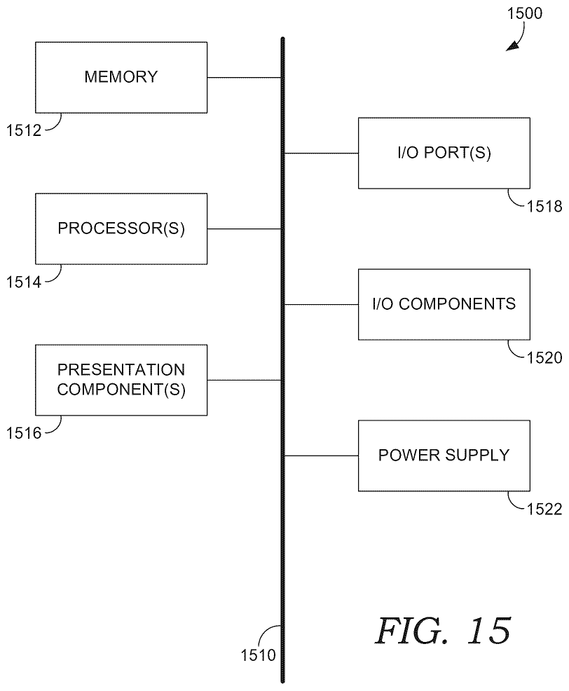

Generally, server 102 is a computing device that implements functional aspects of operating environment 100, such as one or more functions of search engine 110 to facilitate image-based searching by optimizing textual inputs. One suitable example of a computing device that can be employed as server 102 is described as computing device 1500 with respect to FIG. 15. In implementations, server 102 represents a backend or server-side device.

Computing device 104 is generally a computing device that may be used to perform image-based searching using textual inputs. For instance, computing device 104 may receive inputs from an input component corresponding to a text-based input, which can be communicated to search engine 110 for use by its components. Computing device 104 may receive and display items as search results from search engine 110.

As with other components of FIG. 1, computing device 104 is intended to represent one or more computing devices. One suitable example of a computing device that can be employed as computing device 104 is described as computing device 1500 with respect to FIG. 15. In implementations, computing device 104 is a client-side or front-end device. In addition to server 102, computing device 104 may implement functional aspects of operating environment 100, such as one or more functions of search engine 110. It will be understood that some implementations of the technology will comprise either a client-side or front-end computing device, a backend or server-side computing device, or both executing any combination of functions from search engine 110, among other functions or combinations of functions.

Search engine 110 generally receives a text-based input and provides search results of items in response. The search results may be included within a search engine results page (SERP). Items may include any of web pages, images, videos, infographics, articles, research papers, and other types of files, and could include associated descriptions and hyperlinks. Search engine 110 may be configured for general internet or network searching, or may be configure as a search engine to search a specific database or website, such as a search engine that returns item listings on an e-commerce platform.

Broadly, search engine 110, either individually or in coordination with other components or systems, employs functions to receive a search query and provide a SERP of items in response. In doing so, search engine 110 may optimize a text-based input provided as the search query to generate an optimized image-model prompt. The optimized image-model prompt may be used to generate a photo-realistic image. The photo-realistic image may then used by search engine 110 to identify items and return those items as search results to a computing device, such as computing device 104. To do so, search engine 110 may employ optimized image-model prompt generator 112, photo-realistic image generator 114, segmentation engine 116, and image-based searcher 118. It is again noted that search engine 110 is intended to be one example suitable for implementing the technology. However, other arrangements and architectures of components and functions for optimizing text-based inputs for generating search images are intended to be within the scope of this disclosure and understood by those practicing the technology.

Generally, optimized image-model prompt generator 112 generates an optimized image-model prompt from a text-based input. To generate the optimized image-model prompt, optimized image-model prompt generator 112 employs language model 120. The text-based input is provided to language model 120 as an input, and in response, language model 120 outputs the optimized image-model prompt.

In an aspect, language model 120 is a machine learning model, such as a generative AI model. The generative AI model may be a text-based model in that it outputs text that forms the optimized image-model prompt. The optimized image-model prompt expands the text-based input into a textual description. The textual description is a text-based description of an image, such as the photo-realistic image that will be described. The optimized image-model prompt may include a literal description of an image that corresponds to an object of the text-based input. For instance, language model 120 may expand that text-based input to include additional text-based description of an image. In expanding a text-based input, such as text-based input 202, language model 120 may include additional attributes corresponding to the object of the text-based input, including features or characteristics and literal text-based descriptions of these attributes.

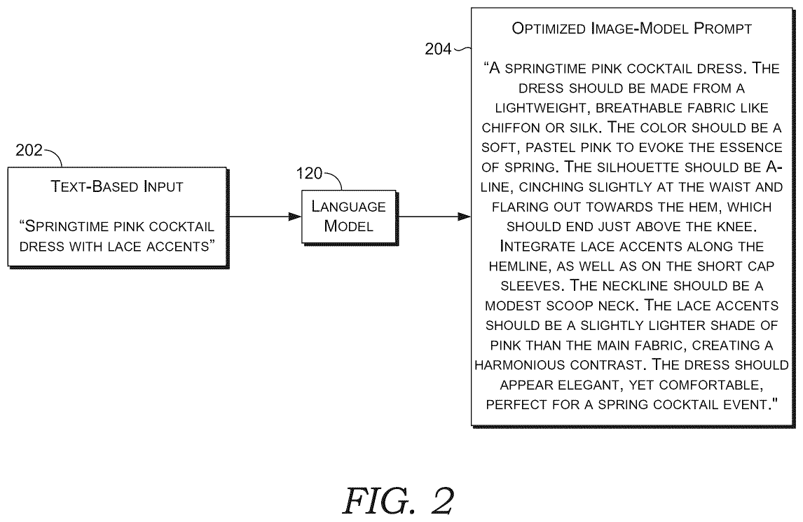

FIG. 2 provides an example use case of language model 120. Here, text-based input 202 is input to language model 120, and the resulting output is optimized image-model prompt 204. Text-based input 202 is an example text-based input that may be received as a search query from a computing device, such as computing device 104. In this example, text-based input 202 recites, “springtime pink cocktail dress with lace accents.” This is input to language model 120, which expands text-based input 202 to generate a literal description of an image comprising the object of text-based input 202—in this case, a “springtime pink cocktail dress with lace accents.” The resulting optimized image-model prompt 204 recites, “A springtime pink cocktail dress. The dress should be made from a lightweight, breathable fabric like chiffon or silk. The color should be a soft, pastel pink to evoke the essence of spring. The silhouette should be A-line, cinching slightly at the waist and flaring out towards the hem, which should end just above the knee. Integrate lace accents along the hemline, as well as on the short cap sleeves. The neckline should be a modest scoop neck. The lace accents should be a slightly lighter shade of pink than the main fabric, creating a harmonious contrast. The dress should appear elegant, yet comfortable, perfect for a spring cocktail event.”

Language model 120 can be trained to generate optimized image-model prompts from text-based inputs. Referring back to FIG. 1, language model 120 can be trained, at least in part, using item corpus 124. Item corpus may include items and item descriptions corresponding to the items. That is, item corpus 124 may include a broad database of textual and general descriptive information. For instance, item corpus 124 may include a wide range of sources, such as websites, books, Wikipedia, scientific articles, news outlets, technical manuals, movie scripts, programming code, educational materials, and other texts, which can generate a broad understanding of human language. Language model 120 can be trained on a dataset comprising such texts.

For example, for a model comprising a transformer architecture, with multiple layers and millions of parameters, the training objective is to minimize the difference between the predicted and actual next word in a given sequence of words of the training data, e.g., the general textual material. This may be achieved using a loss function, such as cross-entropy. The parameters of language model 120 may be optimized using, for example, gradient-based optimization algorithms, such as Adam, or other stochastic optimization. This results in a pretrained base model, which may be used as language model 120 in some cases.

In an aspect, language model 120 can be fine-tuned or further trained on a specific document category, which may be based on the use case of language model 120. The fine-tuning may be done using algorithms similar to those described in training the initial base model. For instance, in a broad use case, such as general internet searching, language model 120 may be trained on item corpus 124. In cases where language model 120 is employed for a particular task or a particular context, a corpus of documents related to that task or concept may be used to train or fine tune language model 120. As an example, for use by an e-commerce website, the language model 120 may be trained on items and item descriptions of items for sale on the e-commerce website. By doing so, language model 120 better contextualizes text-based inputs provided in the context of searching for item listings on the e-commerce website. Fine-tuned models may also be used as language model 120.

It should be noted that the aforementioned training methods involving pre-training and fine-tuning are provided as illustrative examples and are not intended to limit the scope of potential training methodologies that could be employed. Other approaches may include reinforcement learning from human feedback (RLHF); transfer learning from related tasks, where the model is initially trained on a task that is similar but not identical to the target task, and then is fine-tuned on the specific task of interest; and multi-task learning, where the model is trained to perform multiple tasks simultaneously, sharing representations between them to improve overall performance. These training methods can be standalone approaches or can be integrated with other techniques to create a more robust and versatile model, along with new methods that may be incorporated as they are developed.

Based on this training, language model 120 may be suitable for determining a type of information needed to generate the optimized image-model prompt. That is, if after being provided with the text-based input, further information is required to generate the optimized image-model prompt, language model 120 will prompt a user computing device for the specific information needed. This can be done in the form of a dialogue or a back-and-forth information gathering session between language model 120 and the user computing device via optimized image-model prompt generator 112.

In aspects, language model 120 can be given contextual commands to generate the optimized image-model prompt, such as providing a purpose for text-based input (e.g., “you are generating a prompt for a diffusion model”), a level of detail required (e.g., “provide enough detail so that someone could draw the text-based input”), a knowledge lens (e.g., “pretend you are a clothing design”), along with other contextual commands. These commands may be provided within the text-based input. In some cases, these commands are determined from the context of the text-based input and provided by search engine 110. To provide an example, if the text-based input includes a search for a dress, a command indicating that the language model 120 should generate the optimized image-model prompt as if it were a tailor may be provided. Thus, more broadly, search engine 110 may instruct language model 120 to consider itself a manufacturer of the object of the text-based input. In these examples, and more, language model 120 contextualizes this information and formats the response, e.g., the optimized image-model prompt, accordingly. Commands such as these can be used to enhance a literal, text-based description of an object included within a text-based input, where the text-based description includes a text-based pictorial description of the object.

As noted, a user may engage in a dialogue with the language model 120. In aspects, a user may request a modification be made to an image, as will further be discussed. For instance, a user may view an image generated by a language model and want to change an attribute of an object in the image. A text-based input can include a modification, that is, a text-based instruction to modify the image in a particular manner. In doing so, the modification, comprising the text-based input, can be provided to language model 120, which will modify a prior optimized image-model prompt in a manner that includes the modification, or an expanded description thereof, thus generating a modified optimized image-model prompt. Examples of such will be further discussed. The user may engage in this back-and-forth dialogue any number of times until the generated optimized image-model prompt can be used to generate the image the user desires to use as the search image.

Thus, as described, optimized image-model prompt generator 112 may use language model 120 to generate an optimized image-model prompt from a text-based input. It may further receive a text-based input comprising a modification, and from it, modify an initial optimized image-model prompt to generate a modified optimized image-model prompt, which can be used to modify an image to use in an image-based search.

In an embodiment, the modified optimized image-model prompt is manually generated. For instance, the text-based input may be provided to language model 120 to generate an optimized image-model prompt. The optimized image-model prompt may be displayed at a user computing device, such as computing device 104. A text-based input may be received that directly modifies the textual description in the optimized image-model prompt, thus generating the modified optimized image-model prompt that may be used by other components of search engine 110 as described.

Search engine 110 generally employs photo-realistic image generator 114 to generate a photo-realistic image from an optimized image-model prompt. This may also include a modified optimized image-model prompt. The optimized image-model prompt may be accessed or otherwise generated using optimized image-model prompt generator 112, as described above.

To generate a photo-realistic image from the optimized image-model prompt, photo-realistic image generator 114 may employ image model 122. That is, image model 122 receives as an input the optimized image-model prompt and from it outputs a photo-realistic image that depicts an object described by the optimized image-model prompt.

Generally, image model 122 is a machine learning model that can generate images from textual inputs. In an example, image model 122 is a generative AI model that receives text and outputs an image in response. In a specific example, image model 122 is a diffusion model. While general reference is made to a diffusion model, or more broadly, a generative AI model, it will be understood that other text-to-image models may be employed or developed, and such models are intended to be within the scope of this disclosure. Some non-limiting examples may include Generative Adversarial Networks (GANs), Variational Autoencoders (VAEs), and Transformer Models. Image model 122 may be a single AI model or may be a coordination of various models that work to generate images from textual inputs.

In the context of a diffusion model, the training process for converting text to images could include a two-stage mechanism that first corrupts an original image by iteratively adding noise and then reverses this process to generate new image samples based on textual input. In general, there are a number of image datasets that can be used. Some examples include Flickr 30k, IMBD-Wiki, Berkeley Deep Drive, and so forth. The textual descriptions are encoded into a latent space using natural language processing techniques, providing a condition for the generative process. During the diffusion process, image model 122 learns to map this latent textual representation to a series of noisy image states, effectively learning the transition dynamics between the text and the corresponding image. Image model 122 is trained to minimize the difference between the generated image and the actual image corresponding to the textual description. As an example, mean squared error, cross-entropy, or other like functions may be used as the loss function for training. The optimization is typically performed using gradient-based algorithms, e.g., Stochastic Gradient Descent (SGD), Adam, etc. Once trained, image model 122 can take a textual description as input and iteratively refine a noisy image until it generates a new image that closely matches the textual description, thereby effectively converting text to images. This is one example method for training image model 122 such that 122 receives the textual description provided by the optimized image-model prompt and generates an image from it that matches the description of the optimized image-model prompt. Other training methods may be employed as developed or may be employed based on the specific model being used.

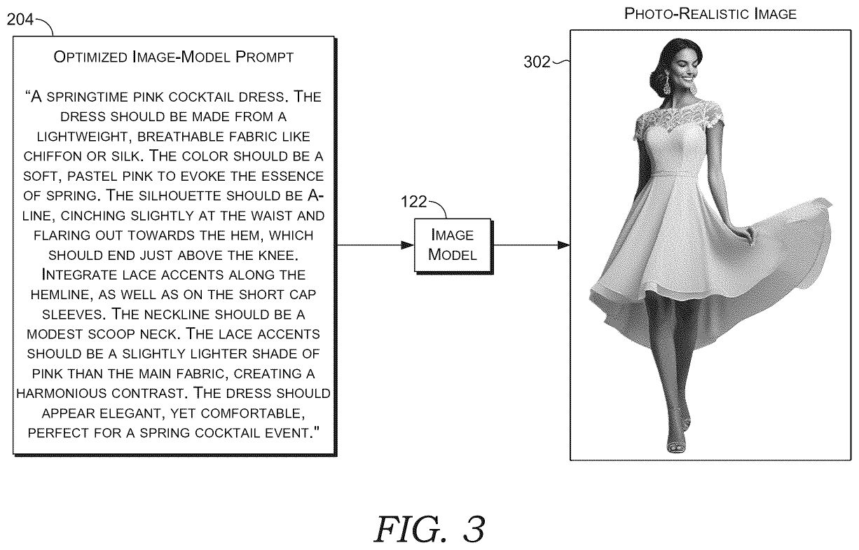

Turning now to FIG. 3, as illustrated, image model 122 can be used to generate photo-realistic image 302 from optimized image-model prompt 204, which was generated in FIG. 2 by language model 120. In general, a photo-realistic image is an image that closely resembles a photograph. It may capture details, textures, lighting, and shadows in a manner that makes it resemble an actual photograph.

In some cases, based on the resulting photo-realistic image, such as photo-realistic image 302, a user may wish to further modify the image. For instance, the image depicts an object, and the object depicts attributes, which are features of the object. Using the example illustrated in FIG. 3, the resulting photo-realistic image 302 includes attributes such as a cinched waist, hemline, sleeves, neckline, and so forth. These attributes can be modified via a modification process. This can be done as part of an iterative process to provide a photo-realistic image that is close to what the user envisions or otherwise intends. It should be noted that at any point in this process, either the first output photo-realistic image or any modified iteration thereof may be used to perform an image-based search, as will be further described.

In an aspect of the technology, the modified image is a modification of a photo. That is, while aspects are described in which a photo-realistic image is modified, the modification process may also be performed on a photograph, e.g., one taken with a camera, or a digital rendering of an image, which may be stored in various image file formats. That is, the initial image being segmented and then modified (e.g., using the image model 122 to render a modified image) may be a photograph. Photographs include photo-realistic images along with photos taken using other known methods, e.g, cameras, computer snips, etc. Once modified by generating the modified image, the iterative process may continue, further using the modified image as the next input should the user wish to continue with modifications. As such, the methods describing the use of an initial phot-realistic image may also be applied to an initial photograph.

To modify an initial photo-realistic image, a text-based modification may be input at the user computing device, such as computing device 104, and received by search engine 110. The modification may include an attribute and a change to the attribute. As an example, the initial photo-realistic image may be presented at a display of the user computing device. Subsequent to generating and presenting the initial photo-realistic image, a modification comprising a text-based input may be received. The modification may also be referred to as a text-based modification.

The text-based modification may be provided to language model 120. Language model 120 may also take as input a prior optimized image-model prompt. In some cases, this is done via a back-and-forth dialogue. That is, language model 120 may have previously generated an optimized image-model prompt that was used to generate a photo-realistic image. The text-based modification may be received based on the photo-realistic image. Language model 120 modifies the prior optimized image-model prompt based on the text-based modification. Language model 120 outputs a modified optimized image-model prompt that includes a modification to the attribute in accordance with the text-based modification.

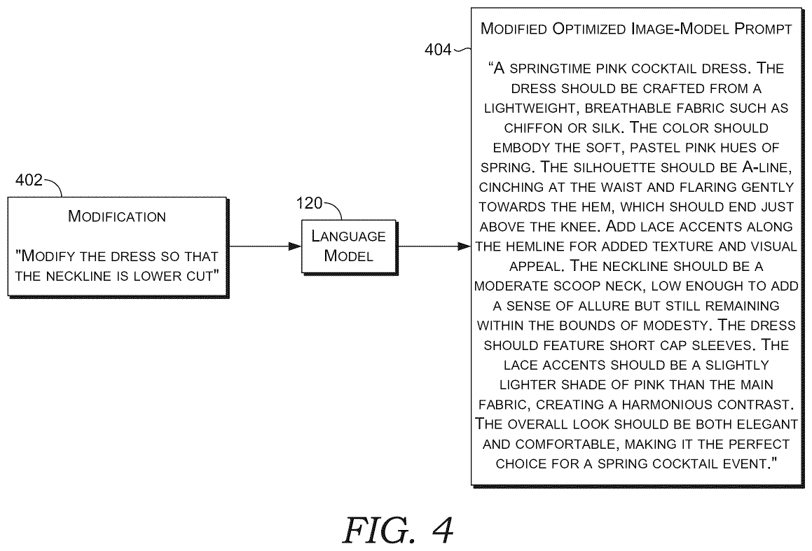

FIG. 4 illustrates an example. Here, modification 402 is received and input to language model 120. In this example, language model 120 modifies the prior optimized image-model prompt, which in this case is optimized image-model prompt 204 illustrated in FIG. 2, to output the resulting modified optimized image-model prompt 404. Here, the modification 402 includes text that describes modifying “the dress so that the neckline is lower cut.” As can be seen, language model 120 outputs modified optimized image-model prompt 404, which includes additional language, such as “the neckline should be a moderate scoop neck, low enough to add a sense of allure but still remaining within the bounds of modesty.” As will be described, modified optimized image-model prompt 404 can be used to modify a resulting image to generate a modified image using photo-realistic image generator 114 employing image model 122. As noted, in some embodiments, a modification may be received by the computing device that directly modifies the textual description within the optimized image-model prompt to generate the modified optimized image-model prompt.

In an aspect, the modified optimized image-model prompt is provided to photo-realistic image generator 114 to generate a photo-realistic image from the modified optimized image-model prompt using image model 122. Thus, in some aspects, the modified optimized image-model prompt may be provided to image model 122, where in response, image model 122 outputs a new photo-realistic image from the modified optimized image-model prompt.

In some aspects, segmentation engine 116 may be employed to identify an attribute in an image, such as a photo-realistic image, and segment the attribute for modifying the image. For example, this may be done responsive to receiving a text-based modification indicating a modification to a particular attribute included in an initial photo-realistic image. Segmentation engine 116 may apply a segmentation mask over an area of an image, such as an initial photo-realistic image, having an identified attribute, such as the attribute identified in the text-based modification. Thus, segmentation search engine 110 may employ semantic segmentation techniques to identify segments of an image and classify those segments as corresponding to a particular attribute.

For instance, segmentation engine 116 may employ a segmentation technique on an image to identify image segments, e.g., pixel areas within the image. As an example, for image segmentation, a convolutional neural network (CNN) may be used. An image dataset such as those already described may be used to train the CNN. Various methods exists for training CNNs for image segmentation, with fully convolutional networks (FCNs) and U-Nets being examples. FCNs are designed to handle various size inputs, making them suitable for use with the present technology. U-Nets can extend the capabilities of FCNs by incorporating skip connections, which help retain details of the image, such as the photo-realistic image, from the input throughout the network's architecture. In an example training method, a CNN is trained using labeled image datasets where each pixel in the image is assigned to a specific category or class. During training, the CNN network learns to recognize patterns and features through backpropagation, aiming to minimize the difference between its predicted segmentation and the ground truth labels. Image classification may be done by the same or different network in order to identify an attribute in the image. CNNs may also be suitable for the classification task. During training, each pixel may be labeled with a particular classification in the training image dataset. These classifications may relate to many different objects. For instance, the pixel classification may relate to various attributes. To minimize these differences during training, mean squared error, cross-entropy loss, or another like algorithm may be used. This is just one example, and other models and other training methods may be employed for image segmentation.

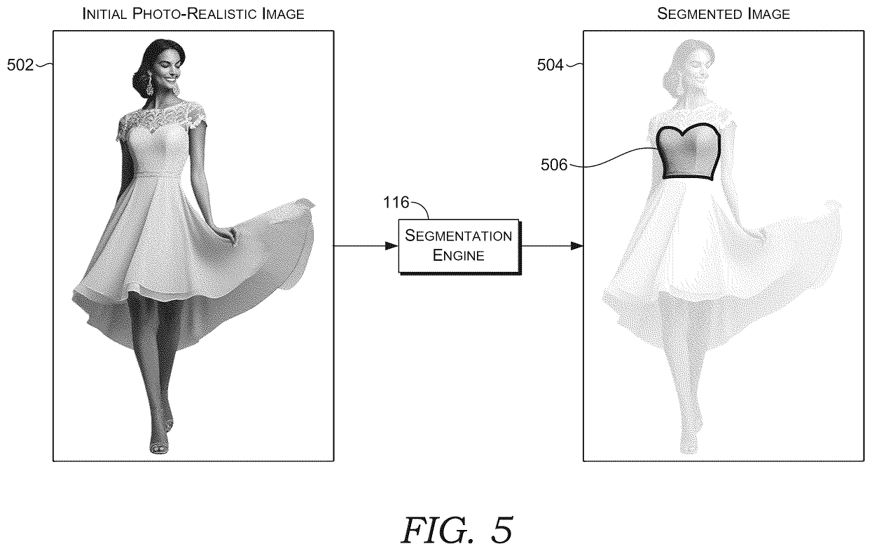

Thus, on receiving a text-based modification comprising an attribute, segmentation engine 116 may be employed to identify the attribute in the image, such as the initial photo-realistic image. Segmentation engine 116 can apply a segmentation mask to an area having the attribute. Turning to FIG. 5 as an example, initial photo-realistic image 502 is provided to segmentation engine 116, which generates segmented image 504 by identifying applying segmentation mask 506 to an area comprising the identified attribute. As noted, this attribute may be identified based on its inclusion in a text-based modification. For example, turning back to FIG. 4, modification 402 included the attribute “neckline” in the text-based modification. Based on this, segmentation engine 116 generates segmented image 504 from initial photo-realistic image 502 by applying segmentation mask 506. In this case, initial photo-realistic image 502 corresponds to photo-realistic image 302 at FIG. 3.

In this way, a user can generate a photo-realistic image such as photo-realistic image 302. The user may desire to change an attribute of photo-realistic image 302, and in doing so, provide a text-based input having a text-based modification, such as the one shown by modification 402. Segmentation engine 116 identifies and segments an area of the initial image, such as initial photo-realistic image 502 that corresponds to the same photo-realistic image 302, to identify the attribute and apply segmentation mask 506 to an area of the image that includes the attribute.

In some aspects, to modify an attribute of an initial photo-realistic image, its corresponding segmented image having the identified attribute is provided to image model 122, along with a modified optimized image-model prompt generated from the text-based modification, as previously described. In doing so, pixels outside of the segmented area can be rendered transparent, such that image model 122 modifies only the non-transparent pixels within the segmented area according to the modified optimized image-model prompt, thus modifying the attribute within the image and generating a modified image in response. Pixels of an image can be rendered transparent by manipulating the alpha channel of the pixel.

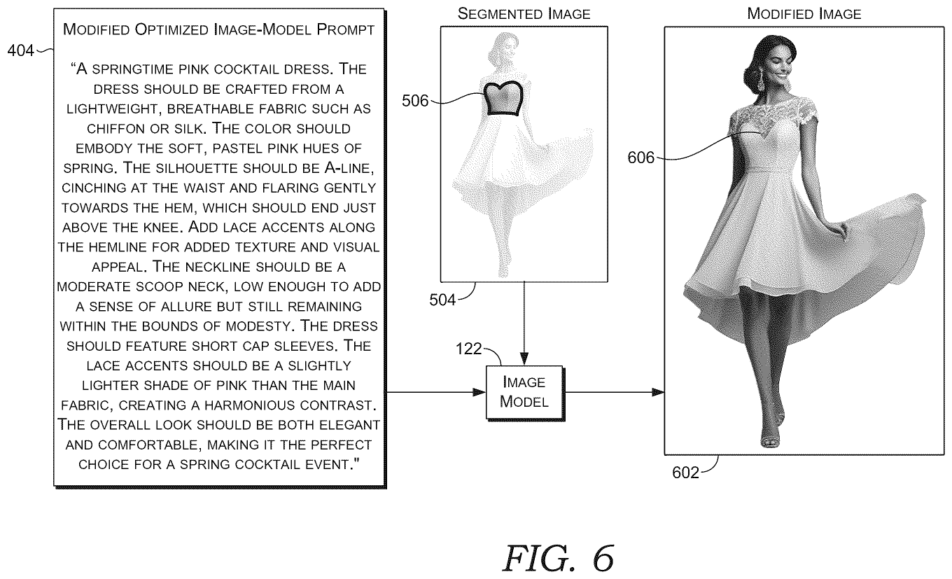

FIG. 6 illustrates an example. In this example, modified optimized image-model prompt 404 and segmented image 504 are input to image model 122. The pixels outside of segmentation mask 506 in this case are rendered as transparent. As such, image model 122, in generating modified image 602 modifies only those pixels within segmentation mask 506, e.g., the non-transparent pixels. The transparent pixels remain the same between the input image, segmented image 504, and the output image, modified image 602. This technique allows the attribute to be modified according to the entire modified optimized image-model prompt, such as modified optimized image-model prompt 404, rendering a modification that realistically fits with the remainder of the image. For instance, as illustrated by modified image 602, the attribute neckline 606 has been modified to cut lower in accordance with the text-based description in modified optimized image-model prompt 404.

Having generated the photo-realistic image, image-based searcher 118 may be employed to identify search results of items using an image-based search. That is, the generated photo-realistic image may be used as the search query during an image-based search to return similar results. It is also noted that, while reference is made to using a photo-realistic image as the object of an image-based search, the photo-realistic image subject to the search may be synonymous with a modified image as well, having been modified by the user to output the final photo-realistic image that the user desires to search. That is, the photo-realistic image provided to image-based searcher 118 to identify search results may be the initial photo-realistic image generated by photo-realistic image generator 114 or may include any number of modifications made by photo-realistic image generator 114, as previously described.

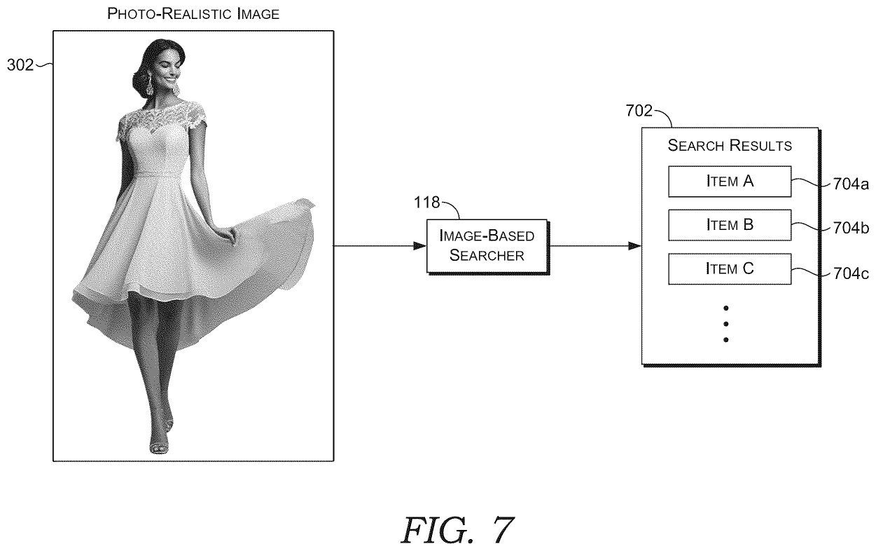

As illustrated in FIG. 7, photo-realistic image 302 is provided to image-based searcher 118 to identify search results 702. Search results 702 comprises one or more items, illustrated here as item A 704a, item B 704b, item C 704c, and so forth. In an embodiment, image-based searcher 118 accesses an index during the image-based search to identify an item. The item is accessed from the index and is provided as a search result responsive to the the photo-realistic image being used as the image-based search query. In the context of the example illustrated in FIG. 7, for instance, image-based searcher 118 accesses an index to retrieve any one or more of item A 704a, item B 704b, item C 704c, or any other items, and returns them as search results 702. The items, such as those in FIG. 7, may be provided to a computing device, such as 104 from which the text-based input was received, as search results for the photo-realistic image, as search results 702 have been provided as search results for photo-realistic image 302 in the illustrated example.

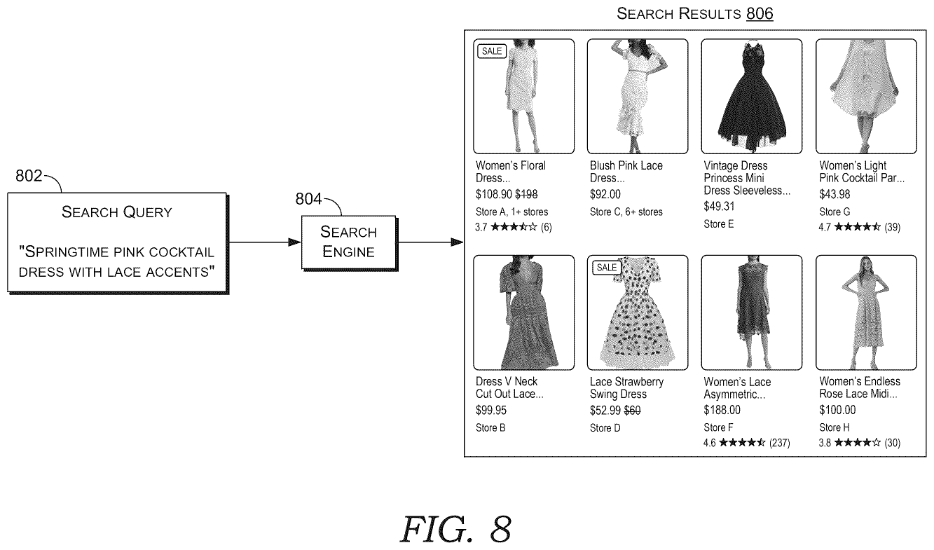

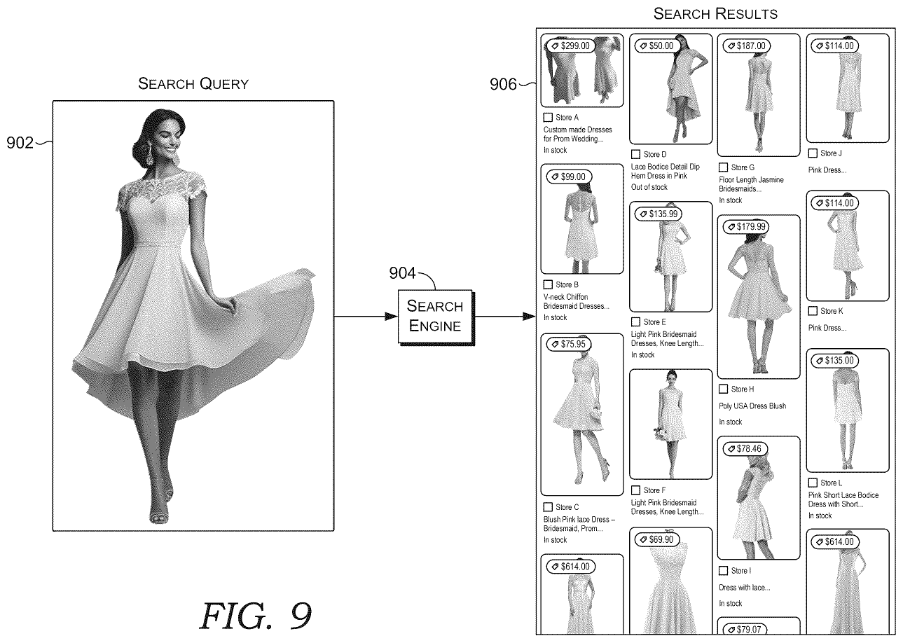

FIG. 8 and FIG. 9 illustrate contrasting results between existing text-based searches and the present technology. FIG. 8 illustrates the results of a text-based search. Here, a common internet search engine was used. Search query 802 was entered into the search engine, illustrated here as search engine 804. As illustrated, search query 802 recited “springtime pink cocktail dress with lace accents.” The top results of search engine 804 responsive to search query 802 are illustrated as search results 806. FIG. 9 illustrates the results of an image search performed using the technology described in this application. Here, a text-based input comprising “springtime pink cocktail dress with lace accents was used to generate the photo-realistic image, in accordance with methods previously described, which is provided as search query 902 in FIG. 9. The same common internet search engine was used, illustrated here as search engine 904, but this time, was used to perform an image-based search using search query 902. The top results of this search are provided as search results 906. Search results 906 appear to include more items aligning with the intent of the input text “springtime pink cocktail dress with lace accents” compared to the items of search results 806.

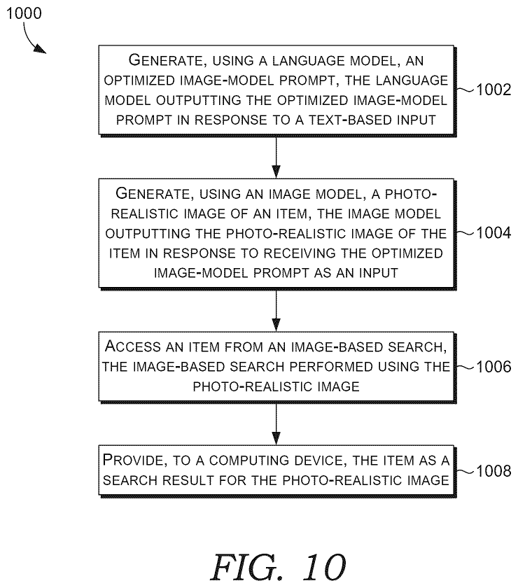

Referring now to FIG. 10, a method 1000 for providing an item as a search result is provided. At block 1002, an optimized image-model prompt is generated. This may be done using optimized image-model prompt generator 112 employing language model 120. The optimized image-model prompt may be generated based on a text-based input, e.g., one received from a computing device at a search engine. In some cases, the language model generates the optimized image-model prompt by expanding the text-based input into a textual description. The textual description may describe an object within a photo-realistic image that is to be generated according to the description. The text-based input may be expanded to the optimized image-model prompt, which comprises text that includes a literal description of attributes of an object identified from the text-based input. To generate the optimized image-model prompt from the text-based input, the language model may be trained on an item corpus comprising items and item descriptions corresponding to the items. If additional information is needed to generate the optimized image-model prompt, optimized image-model prompt generator 112 may communicate a question to the user computing device indicating the additional information that is needed. Upon receiving the additional information, the optimized image-model prompt may be generated.

At block 1004, a photo-realistic image is generated. The photo-realistic image may be generated by an image model, such as image model 122. For instance, this may be done by employing photo-realistic image generator 114. The photo-realistic image is generated from the optimized image-model prompt. That is, the optimized image-model prompt is input to the image model, which outputs the photo-realistic image, where a photo-realistic image depicts an object as described by the textual description in the optimized image-model prompt.

At block 1006, an item is accessed from an image-based search. The photo-realistic image may be used for the image-based search. For instance, image-based searcher 118 may be used to perform the search. In an embodiment, the item may be accessed from an index where an item is identified during the search.

At block 1008, the item is provided to a computing device as a search result for the photo-realistic image. One or more items may be identified and returned as search results. In an aspect, the search results are returned at a SERP to the computing device from which the text-based input was received.

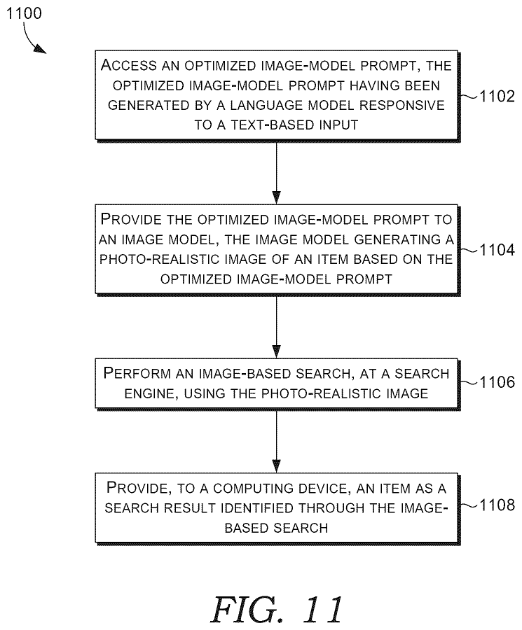

With reference to FIG. 11, a method 1100 is illustrated for providing an item a search result. At block 1102, an optimized image-model prompt is accessed. The optimized image-model prompt may have been generated using a language model such as language model 120. For example, the optimized image-model prompt may have been generated by a language model responsive to a text-based input provided at a search engine at a computing device. The optimized image-model prompt may be an expanded textual description of an object identified within the text-based input, e.g., a literal textual description of the object. In an aspect, the language model used to generate the optimized image-model prompt is trained on an item corpus comprising items and item descriptions corresponding to the items.

At block 1104, the optimized image-model prompt is provided to an image model, e.g., image model 122. This may be done by photo-realistic image generator 114. In response, the image model generates a photo-realistic image in accordance with the textual description within the optimized image-model prompt, e.g., the textual description of the object identified in the text-based input.

At block 1106, an image-based search is performed. For instance, this may be done by image-based searcher 118. The image-based search may be performed to identify an item.

At block 1108, the item is provided to a computing device as a search result for the photo-realistic image. One or more items may be identified and returned as search results. In an aspect, the search results are returned at a SERP to the computing device from which the text-based input was received.

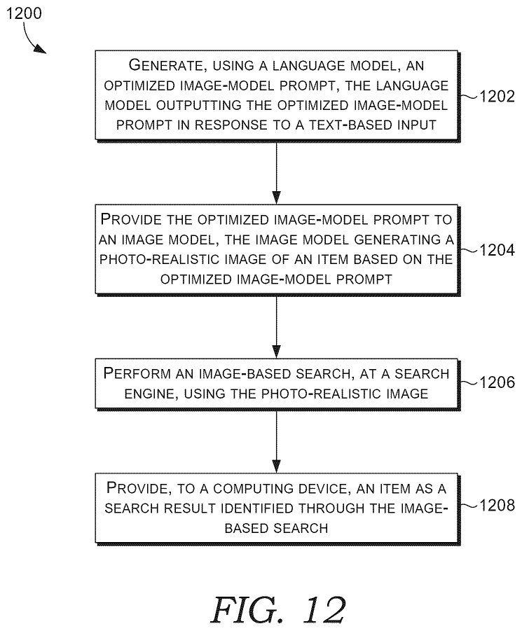

Turning now to FIG. 12, a method 1200 for providing an item as a search result is illustrated. At block 1202, an optimized image-model prompt is generated. The optimized image-model prompt may be generated by, for instance, optimized image-model prompt generator 112 employing language model 120. The language model outputs the optimized image-model prompt in response to a text-based input. The text-based input may be received from a computing device at a search engine. To generate the optimized image-model prompt, the language model expands the text-based input to a textual description of an object that is included in the text-based input, the textual description providing a literal textual description of the object included in the photo-realistic image that will be generated from the optimized image-model prompt. In an aspect, the language model is trained on an item corpus comprising items and item descriptions corresponding to the items.

At block 1204, the optimized image-model prompt is provided to an image model. For instance, this may be image model 122. Responsive to receiving the optimized image-model prompt, the image model generates a photo-realistic image depicting the object according to the textual description in the optimized image-model prompt.

At block 1206, an image-based search is performed. For instance, this may be done by image-based searcher 118. The image-based search may be performed to identify an item.

At block 1208, the item is provided to a computing device as a search result for the photo-realistic image. One or more items may be identified and returned as search results. In an aspect, the search results are returned at a SERP to the computing device from which the text-based input was received.

In any of methods 1000, 1100, and 1200, the methods may include generating the photo-realistic image based on a segmented image. That is, the image model may further receive as an input a segmented image, where the segmented image includes a segmentation mask identifying an area of pixels in the segmented image and corresponding to an attribute of the object in the photo-realistic image. The pixels outside of the segment may be rendered transparent, while the pixels in the segmentation mask are not transparent. In doing so, the image model may generate the photo-realistic image by modifying only the non-transparent pixels within the segmentation mask in accordance with the optimized image-model prompt.

In some aspects, a text-based modification is received. The text-based modification includes a text-based input, e.g., a text-based description that comprises a modification to an attribute depicted in the photo-realistic image. From the text-based modification, a modified optimized image-model prompt can be generated using optimized image-model prompt generator 112 employing language model 120. That is, the text-based modification is input to the language model and the language model outputs the modified optimized image-model prompt. The optimized image-model prompt may also be input to the language model when generating the modified optimized image-model prompt. In some cases, this is done through a dialogue.

A modified image may be generated from the photo-realistic image in some cases. The modified image may include a modification to the attribute identified within the text-based modification.

Turning to method 1300 and method 1400 generally, the methods may be performed individually or in combination with other methods described, such as methods 1000, 1200, and 1300.

Method 1300 illustrates an example method for segmenting an image for use in generating a photo-realistic image, e.g., a modified image. At block 1302, an initial photo-realistic image is accessed. In an embodiment, the initial photo-realistic image is an initial image generated using an image model, such as image model 122. In an aspect, the initial photo-realistic image is an image accessed from a datastore.

At block 1304, the initial photo-realistic image is segmented. For instance, this may be done by segmentation engine 116. The image may be segmented by applying one or more segmentation masks. A segmentation mask may be applied to an area of the initial photo-realistic image that comprises an attribute. The segmentation mask may be applied based on an attribute included in a text-based input, such as text-based modification.

At block 1306, a segmented image comprising transparent pixels is rendered. For instance, the image as segmented at block 1304 comprises one or more segmentation masks corresponding to one or more attributes. The pixels outside of a segmentation mask may be rendered transparent, e.g., by manipulating the alpha channel of the pixel until the pixel is completely transparent.

At block 1308, the segmented image is provided to an image model for generating a photo-realistic image. The generated photo-realistic image may be the photo-realistic image corresponding to the one generated in any of the preceding methods. In some cases, the generated photo-realistic image corresponding to a modified image, e.g., a photo-realistic image having a modification to an attribute generated by the image model in accordance with a text-based input corresponding to a text-based modification.

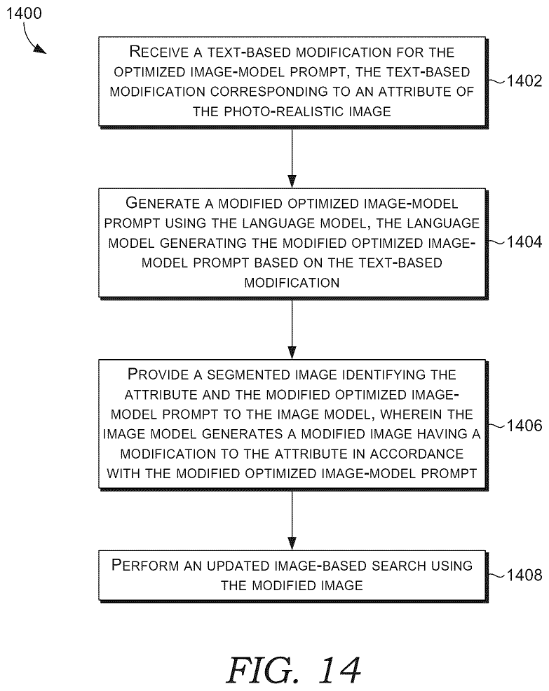

Referring now to FIG. 14, a method 1400 is illustrated for performing an updated image-based search. At block 1402, a text-based modification is received. The text-based modification may be a text-based input received from a computing device, for instance, computing device 104. The text-based modification may be received after generation of an initial photo-realistic image, such as any of the images generated by the preceding methods, including methods 1000, 1100, and 1200. In some cases, the text-based modification describes an attribute included in the initial photo-realistic image.

At block 1404, a modified optimized image-model prompt is generated. This may be done using optimized image-model prompt generator 112 employing language model 120. The modified optimized image-model prompt may include a modification to an optimized image-model prompt previously generated, such as any of the optimized image-model prompts generated by the preceding methods, including methods 1000, 1100, and 1200. The modified optimized image-model prompt may include a textual description describing the initial photo-realistic image and including a textual description describing an update to the attribute according to the text-based input. Thus, in an aspect, the language model 120 receives the text-based modification and the optimized image-model prompt as inputs and generates the modified optimized image-model prompt.

At block 1406, a segmented image and the modified optimized image-model prompt are provided. For instance, the segmented image may be provided to an image model for generating a modified image. The segmented image may be generated using segmentation engine 116. The segmented image may include any one or more segmentation masks applied to the initial photo-realistic image. A segmentation mask may include an area of the segmented image that comprises, e.g., identifies, an attribute as identified in the text-based modification. In some embodiments, the segmented image comprises transparent pixels. The transparent pixels may be outside of the one or more segmentation masks about the attributes. The pixels may be rendered transparent by adjusting an alpha channel for the pixels. The segmented image and the modified optimized image-model prompt may be provided in the same or separate communications with the image model. Responsive to receiving the segmented image and the modified optimized image-model prompt, the image model generates a modified image. The modified image includes a visual modification to the attribute within the segmentation mask of the segmented image in accordance with the textual description provided by the optimized image-model prompt. This process may be performed any number of times to generate the modified image that a user wishes to use as search query.

At block 1408, an updated image-based search is performed. The updated image-based search is performed using the modified image. For instance, this may be done using image-based searcher 118. During the updated image-based search, one or more items are identified and returned as search results corresponding to the modified image. In an embodiment, the updated image-based search is the first search performed by a search engine. That is, a user may generate an initial photo-realistic image using methods previously described, and then modify the image any number of times to generate the modified image (e.g., one desirable to the user), which can be used to generate a set of search results.

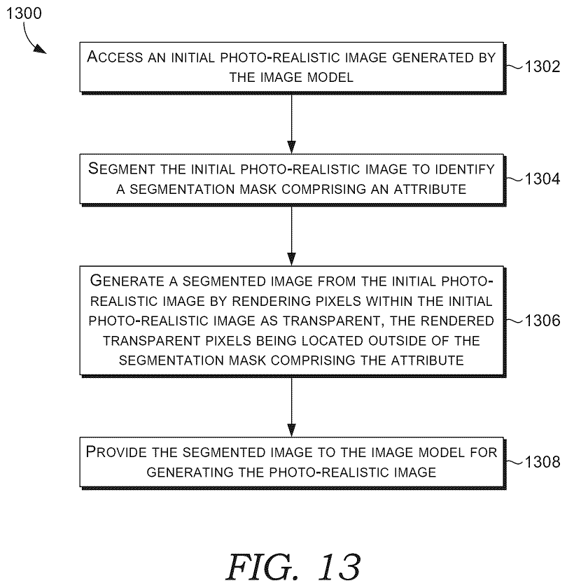

With reference back to FIGS. 10-14, block diagrams are provided respectively illustrating methods 1000, 1100, 1200, 1300, and 1400. Each block of the methods may comprise a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. The methods may be implemented in whole or in part by components of operating environment 100.

Having described an overview of some embodiments of the present technology, an example computing environment in which embodiments of the present technology may be implemented is described below in order to provide a general context for various aspects of the present technology. Referring now to FIG. 15 in particular, an example operating environment for implementing embodiments of the present technology is shown and designated generally as computing device 1500. Computing device 1500 is but one example of a suitable computing environment and is not intended to suggest any limitation as to the scope of use or functionality of the technology. Computing device 1500 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 15, computing device 1500 includes bus 1510, which directly or indirectly couples the following devices: memory 1512, one or more processors 1514, one or more presentation components 1516, input/output (I/O) ports 1518, input/output components 1520, and illustrative power supply 1522. Bus 1510 represents what may be one or more buses (such as an address bus, data bus, or combination thereof). Although the various blocks of FIG. 15 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 15 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 15 and with reference to “computing device.”

Computing device 1500 typically includes a variety of computer-readable media. Computer-readable media can be any available media that can be accessed by computing device 1500 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1500. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1512 includes computer-storage media in the form of volatile or non-volatile memory. The memory may be removable, non-removable, or a combination thereof. Example hardware devices include solid-state memory, hard drives, optical-disc drives, etc. Computing device 1500 includes one or more processors that read data from various entities, such as memory 1512 or I/O components 1520. Presentation component(s) 1516 presents data indications to a user or other device. Example presentation components include a display device, speaker, printing component, vibrating component, etc.

I/O ports 1518 allow computing device 1500 to be logically coupled to other devices, including I/O components 1520, some of which may be built-in. Illustrative components include a microphone, joystick, game pad, satellite dish, scanner, printer, wireless device, etc. The I/O components 1520 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1500. Computing device 1500 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1500 may be equipped with accelerometers or gyroscopes that enable detection of motion. The output of the accelerometers or gyroscopes may be provided to the display of computing device 1500 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, components for optimizing text-based input to generate images for image-based searching can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to search engine 110, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of search engine 110, among other functions, may be performed by server 102, computing device 104, or any other component, in any combination. For example, in a particular aspect, search engine 110 may optimize a text-based input at a server(s) to generate an optimized image-model prompt, and communicate the optimized image-model prompt to another server that generates the photo-realistic image from the optimized image-model prompt, and then received the photo-realistic image from the server to which it communicated the prompt. This is just one example, and other example combinations and configurations within the context of this disclosure will be understood by those of ordinary skill in the art.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that may be practiced from the forgoing description include, but are not limited to the following examples:

Aspect 1: A method performed by one or more processors, the method comprising: generating, using a language model, an optimized image-model prompt, the language model outputting the optimized image-model prompt in response to a text-based input; generating, using an image model, a photo-realistic image of an item, the image model outputting the photo-realistic image of the item in response to receiving the optimized image-model prompt as an input; accessing an item from an image-based search, the image-based search performed using the photo-realistic image; and providing, to a computing device, the item as a search result for the photo-realistic image.

Aspect 2: A system comprising: at least one processor; and one or more computer storage media storing computer-readable instructions thereon that when executed by the at least one processor cause the at least one processor to perform operations comprising: accessing an optimized image-model prompt, the optimized image-model prompt having been generated by a language model responsive to a text-based input; providing the optimized image-model prompt to an image model, the image model generating a photo-realistic image of an item based on the optimized image-model prompt; performing an image-based search, at a search engine using the photo-realistic image; and providing, to a computing device, an item as a search result identified through the image-based search.

Aspect 3: One or more computer storage media storing computer-readable instructions thereon that, when executed by a processor, cause the processor to perform a method comprising: generating, using a language model, an optimized image-model prompt, the language model outputting the optimized image-model prompt in response to a text-based input; providing the optimized image-model prompt to an image model, the image model generating a photo-realistic image of an item based on the optimized image-model prompt; performing an image-based search, at a search engine, using the photo-realistic image; and providing, to a computing device, an item as a search result identified through the image-based search.

Aspect 4: Any of Aspects 1-3, wherein the language model is trained on an item corpus comprising items and item descriptions corresponding to the items.

Aspect 5: Any of Aspects 1-4, wherein the language model generates the optimized image-model prompt by expanding the text-based input into a textual description of an object in the text-based input.

Aspect 6: Any of Aspects 1-5, further comprising providing, to the image model, a segmented image comprising transparent pixels, wherein the photo-realistic image is generated by the image model based on the segmented image.

Aspect 7: Aspect 6, further comprising determining the transparent pixels based on a segmentation mask identifying an attribute of the item.

Aspect 8: Any of Aspects 1-7, further comprising: accessing an initial photo-realistic image generated by the image model; segmenting the initial photo-realistic image to identify a segmentation mask comprising an attribute; generating a segmented image from the initial photo-realistic image by rendering pixels within the initial photo-realistic image as transparent, the rendered transparent pixels being located outside of the segmentation mask comprising the attribute; and providing the segmented image to the image model for generating the photo-realistic image.

Aspect 9: Any of Aspects 1-8, further comprising: receiving a text-based modification for the optimized image-model prompt, the text-based modification corresponding to an attribute of the photo-realistic image; generating a modified optimized image-model prompt using the language model, the language model generating the modified optimized image-model prompt based on the text-based modification; providing a segmented image identifying the attribute and the modified optimized image-model prompt to the image model, wherein the image model generates a modified image having a modification to the attribute in accordance with the modified optimized image-model prompt; and performing an updated image-based search using the modified image.

What is claimed is:

1. A method for image-based searching performed by one or more processors, the method comprising:
generating, using a language model, an optimized image-model prompt, the language model outputting the optimized image-model prompt in response to a text-based input;
generating, using an image model, a photo-realistic image of an item, the image model outputting the photo-realistic image of the item in response to receiving the optimized image-model prompt as an input;
accessing an item from an image-based search, the image-based search performed using the photo-realistic image; and
providing, to a computing device, the item as a search result for the photo-realistic image.

2. The method of claim 1, wherein the language model is trained on an item corpus comprising items and item descriptions corresponding to the items.

3. The method of claim 1, wherein the language model generates the optimized image-model prompt by expanding the text-based input into a textual description of an object in the text-based input.

4. The method of claim 1, further comprising providing, to the image model, a segmented image comprising transparent pixels, wherein the photo-realistic image is generated by the image model based on the segmented image.

5. The method of claim 4, further comprising determining the transparent pixels based on a segmentation mask identifying an attribute of the item.

6. The method of claim 1, further comprising:
accessing an initial photo-realistic image generated by the image model;
segmenting the initial photo-realistic image to identify a segmentation mask comprising an attribute;
generating a segmented image from the initial photo-realistic image by rendering pixels within the initial photo-realistic image as transparent, the rendered transparent pixels being located outside of the segmentation mask comprising the attribute; and
providing the segmented image to the image model for generating the photo-realistic image.

7. The method of claim 1, further comprising:
receiving a text-based modification for the optimized image-model prompt, the text-based modification corresponding to an attribute of the photo-realistic image;
generating a modified optimized image-model prompt using the language model, the language model generating the modified optimized image-model prompt based on the text-based modification;
providing a segmented image identifying the attribute and the modified optimized image-model prompt to the image model, wherein the image model generates a modified image having a modification to the attribute in accordance with the modified optimized image-model prompt; and
performing an updated image-based search using the modified image.

8. A system for image-based searching, the system comprising:
at least one processor; and
one or more computer storage media storing computer-readable instructions thereon that when executed by the at least one processor cause the at least one processor to perform operations comprising:
accessing an optimized image-model prompt, the optimized image-model prompt having been generated by a language model responsive to a text-based input;
providing the optimized image-model prompt to an image model, the image model generating a photo-realistic image of an item based on the optimized image-model prompt;
performing an image-based search, at a search engine, using the photo-realistic image; and
providing, to a computing device, an item as a search result identified through the image-based search.

9. The system of claim 8, wherein the language model is trained on an item corpus comprising items and item descriptions corresponding to the items.

10. The system of claim 8, wherein the language model generates the optimized image-model prompt by expanding the text-based input into a textual description of an object in the text-based input.

11. The system of claim 8, further comprising providing, to the image model, a segmented image comprising transparent pixels, wherein the photo-realistic image is generated by the image model based on the segmented image.

12. The system of claim 11, further comprising determining the transparent pixels based on a segmentation mask identifying an attribute of the item.

13. The system of claim 8, further comprising:
accessing an initial photo-realistic image generated by the image model;
segmenting the initial photo-realistic image to identify a segmentation mask comprising an attribute;
generating a segmented image from the initial photo-realistic image by rendering pixels within the initial photo-realistic image as transparent, the rendered transparent pixels being located outside of the segmentation mask comprising the attribute; and
providing the segmented image to the image model for generating the photo-realistic image.

14. One or more computer storage media storing computer-readable instructions thereon that, when executed by a processor, cause the processor to perform a method for image-based searching, the method comprising:
generating, using a language model, an optimized image-model prompt, the language model outputting the optimized image-model prompt in response to a text-based input;
providing the optimized image-model prompt to an image model, the image model generating a photo-realistic image of an item based on the optimized image-model prompt;
performing an image-based search, at a search engine, using the photo-realistic image; and
providing, to a computing device, an item as a search result identified through the image-based search.

15. The media of claim 14, wherein the language model is trained on an item corpus comprising items and item descriptions corresponding to the items.

16. The media of claim 14, wherein the language model generates the optimized image-model prompt by expanding the text-based input into a textual description of an object in the text-based input.

17. The media of claim 14, further comprising providing, to the image model, a segmented image comprising transparent pixels, wherein the photo-realistic image is generated by the image model based on the segmented image.

18. The media of claim 17, further comprising determining the transparent pixels based on a segmentation mask identifying an attribute of the item.

19. The media of claim 14, further comprising:
accessing an initial photo-realistic image generated by the image model;
segmenting the initial photo-realistic image to identify a segmentation mask comprising an attribute;
generating a segmented image from the initial photo-realistic image by rendering pixels within the initial photo-realistic image as transparent, the rendered transparent pixels being located outside of the segmentation mask comprising the attribute; and
providing the segmented image to the image model for generating the photo-realistic image.

20. The media of claim 14, further comprising:
receiving a text-based modification for the optimized image-model prompt, the text-based modification corresponding to an attribute of the photo-realistic image;
generating a modified optimized image-model prompt using the language model, the language model generating the modified optimized image-model prompt based on the text-based modification;
providing a segmented image identifying the attribute and the modified optimized image-model prompt to the image model, wherein the image model generates a modified image having a modification to the attribute in accordance with the modified optimized image-model prompt; and
performing an updated image-based search using the modified image.
